(19) United States
(12) Patent Application Publication
(10) Pub. No.: US 2014/0283989 A1
(43) Pub. Date: Sep. 25, 2014

(54) METHOD OF ATTACHING ARMORING SHEETS FOR WIRE HARNESS

(71) Applicant: Yazaki Corporation, Tokyo (JP)

(72) Inventor: Yoichi TAKANO, Makinohara-shi (JP)

(73) Assignee: Yazaki Corporation, Tokyo (JP)

(21) Appl. No.: 14/221,568

(22) Filed: Mar. 21, 2014

(30) Foreign Application Priority Data
Mar. 22, 2013 (JP) 2013-059249

(51) Int. Cl. B32B 37/10

(52) U.S. Cl. CPC B32B 37/1018
USPC 156/285

(57) ABSTRACT

A method of attaching armoring sheets for a wire harness includes following steps. In a first armoring sheet setting step, one of a pair of the armoring sheets is set in a positioning recess formed in a setting jig to fit side end surfaces of the one of the armoring sheets to insides of opposing inner side surfaces of the positioning recess. In a wire setting step, wires are set in the positioning recess. In a second armoring sheet setting step, the other of the armoring sheets is set in the positioning recess so as to cover the wires. In a vacuum bonding step, vacuuming is performed to bond the armoring sheets to each other so that side end portions of the armoring sheets are in close contact with each other.

### BACKGROUND

The present invention relates to a method of attaching armoring sheets for a wire harness in which a pair of armoring sheets are bonded to each other by vacuuming, whereby the armoring sheets are attached to a portion where a plurality of wires of a wire harness are bundled, in a covering manner.

In a wire harness which is used in routing of wires in a vehicle or the like, conventionally, an armoring member is used for the purposes of bundling, protection, waterproofing, and the like, and attached so that a plurality of wires are bundled. For example, Patent Document 1 discloses a method of attaching armoring sheets for a wire harness in which the armoring sheets that are sheet-like armoring members are attached by vacuuming.

In the method of attaching armoring sheets for a wire harness which is disclosed in Patent Document 1, the armoring sheets are bonded to each other in a state where a plurality of wires are guided by a guide member.

[Patent Document 1] JP-A-10-3828

### SUMMARY

It is therefore one advantageous aspect of the present invention to provide a method of attaching armoring sheets for a wire harness in which side end portions of the armoring sheets bonded together can be surely bonded to each other.

According to one advantage of the invention, there is provided a method of attaching armoring sheets for a wire harness, comprising:

a first armoring sheet setting step of setting one of a pair of the armoring sheets in a positioning recess formed in a setting jig to fit side end surfaces of the one of the armoring sheets to insides of opposing inner side surfaces of the positioning recess, so as to position the one of the armoring sheets;

a wire setting step of setting wires in the positioning recess so as to place a wire bundled portion on the one of the armoring sheets while forming gaps with respect to the opposing inner side surfaces, wherein the wire bundled portion is a portion in which the wires of the wire harness are bundled;

a second armoring sheet setting step of setting the other of the armoring sheets in the positioning recess to fit side end surfaces of the other of the armoring sheets to the insides of the opposing inner side surfaces, so as to cover the wire bundled portion; and

a vacuum bonding step of performing vacuuming to bond the armoring sheets which are set in the positioning recess, to each other, so that side end portions of the armoring sheets are in close contact with each other in a state that the wire bundled portion is interposed between the armoring sheets.

A distance between the opposing inner side surfaces may be adjusted so that a region which is minimum necessary for bonding the side end portions of the armoring sheets which are fitted to the positioning recess is formed.

In the wire setting step, the wire bundled portion may be guided by guide pins so as to maintain the gaps.

The method may further comprise a fixing member setting step of setting a fixing member to the one of the armoring sheets so that a part of the fixing member is disposed on a bonding surface of the one of the armoring sheets, wherein the fixing member is configured to fix the wire harness to a mating member.

In the first armoring sheet setting step, the one of the armoring sheets may be set in the positioning recess together with the fixing member,

In the second armoring sheet setting step, the other of the armoring sheets may be set in the positioning recess so as to cover the wire bundled portion and the part of the fixing member.

In the vacuum bonding step, the armoring sheets which are set in the positioning recess may be bonded to each other so that the side end portions are in close contact with each other in a state that the wire bundled portion and the part of the fixing member are interposed between the armoring sheets.

In the vacuum bonding step, a plurality of parts of the armoring sheets which are set in a plurality of positions in the positioning recess may be bonded to each other by being vacuumed concurrently.

### BRIEF DESCRIPTION OF DRAWINGS

FIG. 1 is a perspective view showing a vacuum packaging apparatus which is used in a method of attaching armoring sheets for a wire harness according to an embodiment of the invention, and a wire harness in a state where it is set in the vacuum packaging apparatus.

FIG. 2 is a perspective view showing a state where the wire harness shown in FIG. 1 is set in the vacuum packaging apparatus.

FIG. 3 is a perspective view of the wire harness shown in FIG. 1 in which wires are illustrated while armoring sheets are shown in a see-through manner.

FIGS. 4A and 4B are views showing one of a pair of armoring sheets in the wire harness shown in FIG. 1, and a fixing member attached to the wire harness.

FIG. 5 is a perspective view of a setting jig shown in FIG. 1.

FIGS. 6A to 6E are views showing a method of attaching armoring sheets for a wire harness.

FIG. 7 is a sectional view showing a setting jig used in a method of attaching armoring sheets for a wire harness according to a first modification of the invention, in a state where the one of the armoring sheets and a plurality of wires are set in a positioning recess of the setting jig.

FIG. 8A is a perspective view showing a state where the one of the armoring sheets is set in the setting jig shown in FIG. 7, and FIG. 8B is a top view of FIG. 8A.

FIG. 9 is a sectional view showing a setting jig used in a method of attaching armoring sheets for a wire harness according to a second modification of the invention, in a state where the one of the armoring sheets and a plurality of wires are set in a positioning recess of the setting jig.

FIG. 10A is a perspective view showing a state where the one of the armoring sheets is set in the setting jig shown in FIG. 9, and FIG. 10B is a top view of FIG. 10A.

FIG. 11 is a sectional view showing a setting jig used in a method of attaching armoring sheets for a wire harness according to a third modification of the invention, in a state where the one of the armoring sheets and a plurality of wires are set in a positioning recess of the setting jig.

FIG. 12A is a perspective view showing a state where the one of the armoring sheets is set in the setting jig shown in FIG. 11, and FIG. 12B is a top view of FIG. 12A.

### DETAILED DESCRIPTION OF EXEMPLIFIED EMBODIMENTS

In the method of attaching armoring sheets for a wire harness which is disclosed in Patent Document 1, one of the armoring sheets which are to be bonded together must be set in a state where side end portions of the sheet are upward bent along the guide member, in order to ensure portions which are to be bonded to the other armoring sheet. In the case where vacuuming is performed in the state where the side end portions of the armoring sheet are bent, there is a possibility that the side end portions of the armoring sheets which are disposed in pairs are not suitably bonded together.

It is therefore one advantageous aspect of the present invention to provide a method of attaching armoring sheets for a wire harness in which side end portions of armoring sheets that are to be bonded together can be surely bonded to each other.

Hereinafter, a preferred embodiment of the method of attaching armoring sheets for a wire harness according to the invention will be described in detail with reference to the drawings.

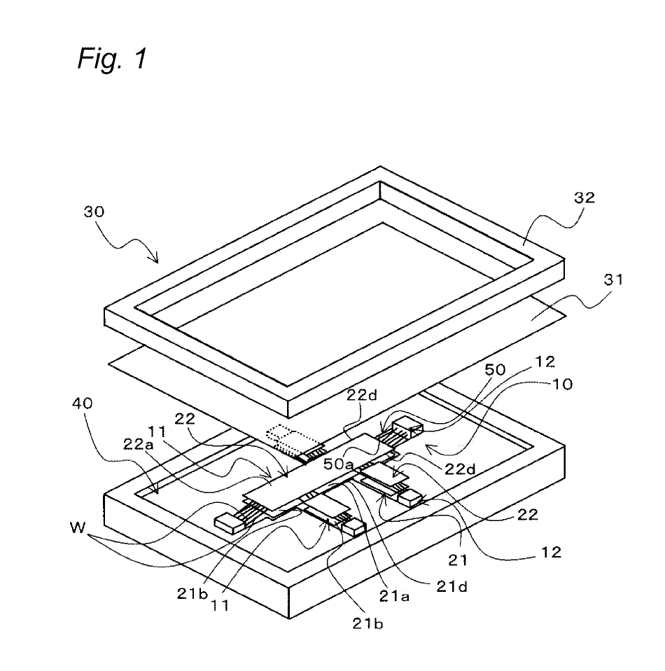

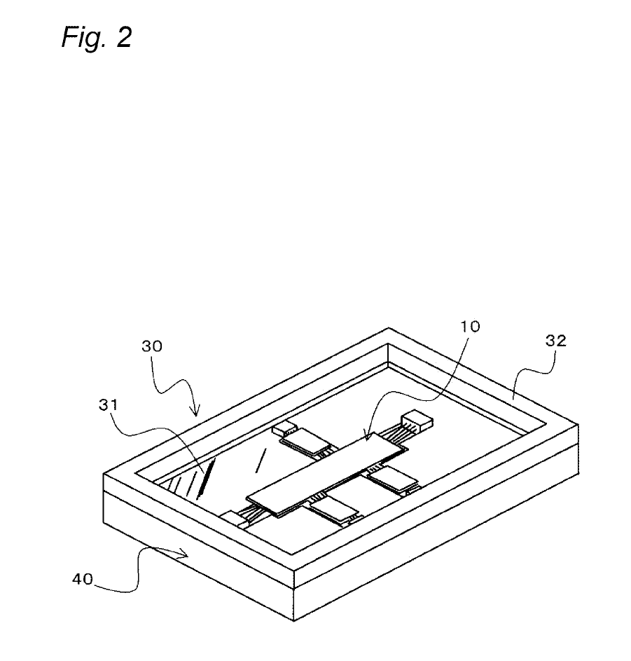

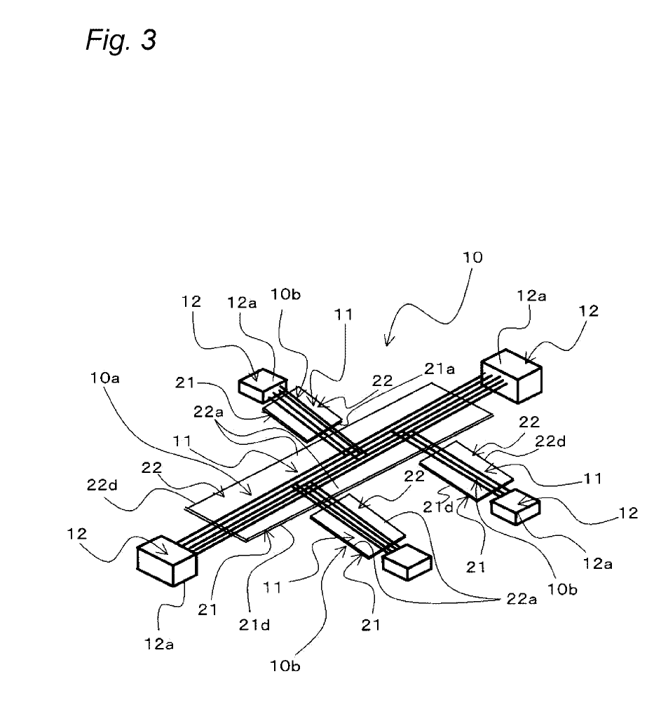

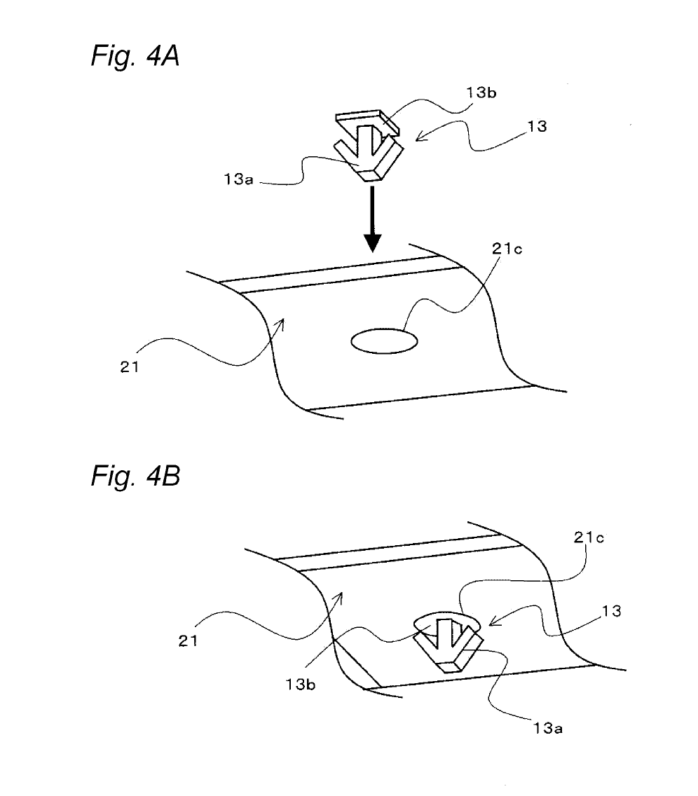

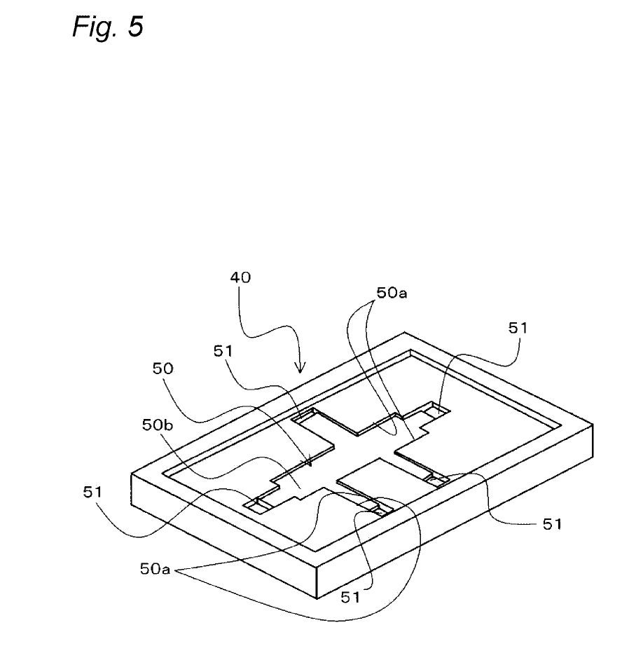

FIG. 1 is a perspective view showing a vacuum packaging apparatus 30 which is used in a method of attaching armoring sheets for a wire harness according to the embodiment of the invention, and a wire harness 10 in a state where it is set in the vacuum packaging apparatus 30. FIG. 2 is a perspective view sowing a state where the wire harness 10 shown in FIG. 1 is set in the vacuum packaging apparatus 30. FIG. 3 is a perspective view of the wire harness shown 10 in FIG. 1 in which wires W are illustrated while armoring sheets 21, 22 are shown in a see-through manner. FIGS. 4A and 4B are views showing one armoring sheet 21 of the a pair of armoring sheets 21, 22 in the wire harness 10 shown in FIG. 1, and a fixing member 13 attached to the wire harness 10. FIG. 5 is a perspective view of a setting jig 40 shown in FIG. 1.

In the method of attaching armoring sheets for a wire harness according to the embodiment of the invention, the armoring sheets 21, 22 are vacuum bonded so as to interpose therebetween wire bundled portions 11 in which a plurality of wires of the wire harness 10 that are used in routing of wires in a vehicle or the like, thereby attaching the armoring sheets 21, 22 to the wire bundled portions 11 so as to cover the wire bundled portions.

In the method of attaching armoring sheets for a wire harness, a dedicated jig 40 (hereinafter, referred to as “setting jig”) is installed to the vacuum packaging apparatus 30 which is used for, for example, vacuum-packing an electric component, and the resulting configuration is used as a vacuuming apparatus.

First, the wire harness 10 will be described.

As shown in FIG. 3, the wire harness 10 includes: a trunk portion 10a in which a plurality of wires are bundled; and a plurality of branch portions 10b which branch off from the trunk portion 10a, and in each of which a connector 12 is disposed in an end portion. In each of the connectors 12, a shell is configured by a connector housing 12a. The armoring sheets 21, 22 are bonded to each other so as to interpose therebetween the wire bundled portions 11 which are portions where the plurality of wires of the trunk portion and the branch portions are bundled.

Each of the armoring sheets 21, 22 is a sheet which is made of polypropylene (PP), polyvinyl chloride (PVC), polyethylene (PE), urethane, or the like, and which is cut into a rectangular shape. An adhesive agent is applied to the surfaces to be bonded together.

The armoring sheets 21, 22 are not limited to those in which an adhesive agent is applied to the surfaces to be bonded together, and may be bonded to each other by using a double-sided adhesive tape, or a self-adhesive function.

The dimensions of the armoring sheets 21, 22 are adjusted so that the wire bundled portions 11 are interposed between the sheets, and the side end portions 21a, 22a are closely bonded to each other. In the embodiment, the dimensions of the armoring sheets 21, 22 are adjusted so that a region which is minimum necessary for bonding the side end portions 21a, 22a of the armoring sheets 21, 22 is formed.

The wire harness 10 further includes a fixing member 13 for fixing the wire harness 10 to a predetermined position of a mating member. The mating member is a panel (not shown) or the like. As shown in FIGS. 4A and 4B, the fixing member 13 includes: an attachment end side fixing portion 13a that is to be passed through an attachment hole formed in the mating member to which the wire harness 10 is to be attached, and that functions as an engaging portion; and a wire harness side fixing portion 13b that is to be located so as to enter toward the side of a bonding surface 21b of the one armoring sheet 21 of the armoring sheets 21, 22, the bonding surface being to be bonded to the other armoring sheet 22, and that functions as a portion to be fixed to the wire harness 10.

The wire harness side fixing portion 13b is configured so as to be located on the side of the bonding surface 21b through a hole portion 21c formed in the one armoring sheet 21. The attachment end side fixing portion 13a which is a part of the fixing member 13 is placed between the one armoring sheet 21 of the armoring sheets 21, 22, and the wire bundled portions 11, whereby, in the case where the armoring sheets 21, 22 are bonded to each other, the attachment end side fixing portion 13a is fixed together with the one armoring sheet 21 to the wire harness 10.

As shown in FIG. 1, the vacuum packaging apparatus 30 has the setting jig 40 which is attached on a vacuum chamber (not shown), a vacuum sheet 31, and a vacuum press frame 32.

As shown in FIG. 5, the setting jig 40 includes a plate member. A positioning recess 50 having a function of positioning the armoring sheets 21, 22 with respect to the wire bundled portions 11 is disposed in the setting jig 40.

In the setting jig 40, vacuum holes which include a vacuum hole 41 described later, and which are not illustrated in the figure are formed in a plurality of places so as to pass through in the thickness direction of the setting jig 40.

The positioning recess 50 is formed along the routing geometry of the wire W in a state where the wire harness 10 is placed in a natural state on a plane.

In the positioning recess 50, the distance between opposing inner side surfaces 50a, 50a is adjusted so that the region which is minimum necessary for bonding the side end portions 21a, 22a of the armoring sheets 21, 22 fitted to the positioning recess 50 is formed.

The positioning recess 50 is formed so that the recess bottom surfaces 50b of portions where the connector housings 12a are respectively placed are formed deeper correspondingly with the thickness of the connector housings 12a which are thicker than other components, and housing fitting portions 51 into which the connector housings 12a are respectively fitted are formed.

In the case the wire harness 10 is fitted to the positioning recess 50, therefore, steps formed by the connector housings 12a are decreased in the whole upper surface of the wire harness 10, and hence the vacuum sheet 31 is easily in close contact with the upper surface. Consequently, vacuuming is performed more easily by the vacuum packaging apparatus 30.

The vacuum sheet 31 covers the upper surface opening of the setting jig 40, thereby forming a vacuum enclosed space. When vacuumed, the vacuum sheet is in close contact with the whole upper surface of the wire harness 10 which is set in the setting jig 40, while pressing the whole upper surface of the wire harness.

The vacuum press frame 32 cooperates with the setting jig 40 to clamp an outer edge portion of the vacuum sheet 31, thereby fixing the vacuum sheet 31.

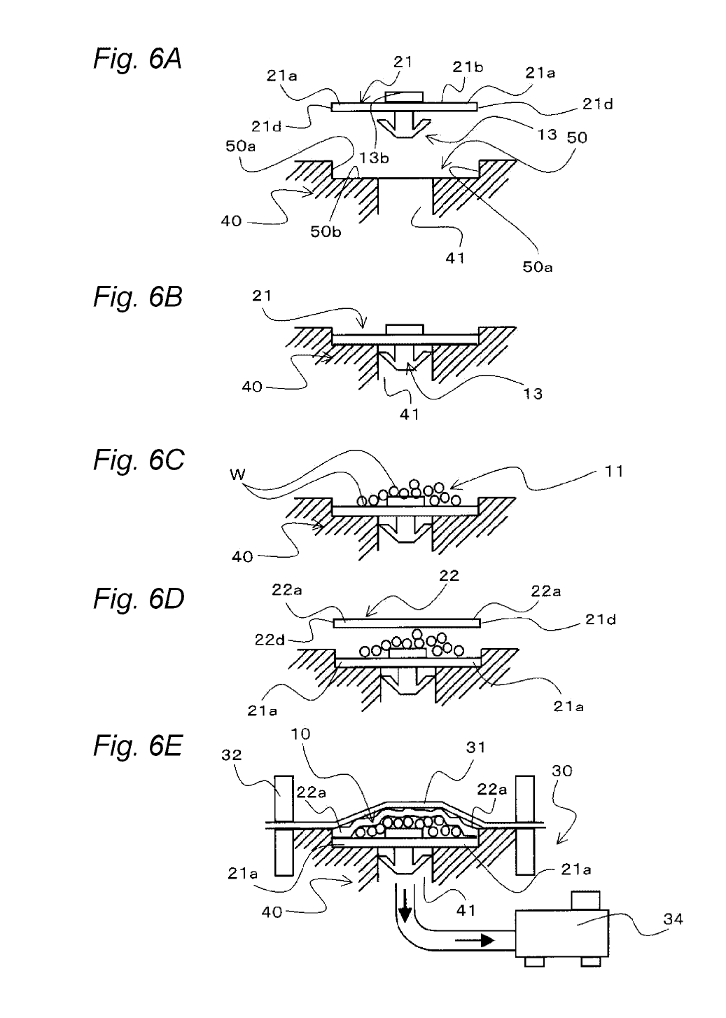

Here, a method of attaching the armoring sheets for the wire harness will be described with reference to FIGS. 6A to 6E.

FIGS. 6A to 6E are views showing the method of attaching the armoring sheets for the wire harness.

In a fixing member setting step, first, the fixing member 13 is set so that the wire harness side fixing portion 13b which is a part of the fixing member 13 enters in the side of the bonding surface 21b of the one armoring sheet 21, the bonding surface being to be bonded to the other armoring sheet 22 (see FIG. 6A).

In a first armoring sheet setting step, then, the one armoring sheets 21 of the armoring sheets 21, 22 are set at positions of the positioning recess 50 corresponding to the wire bundled portions 11 (see FIG. 6B). In this step, the one armoring sheets 21 are set in the positioning recess 50 so that the side end surfaces 21d, 21d of the one armoring sheet 21 are fitted to the insides of the opposing inner side surfaces 50a, 50a of the positioning recess 50.

As a result, the one armoring sheets 21 are positioned and set to a plurality of places of the positioning recess 50 correspondingly with the wire bundled portions 11.

In this step, the attachment end side fixing portion 13a is fitted into the vacuum hole 41 which is one of the above-described vacuum holes, and which functions as a hole for vacuuming and also as a positioning and guiding hole for the fixing member 13, thereby assisting in positioning of the one armoring sheets 21.

In a wire setting step, then, the plurality of wires W are set in the positioning recess 50 so that the wire bundled portions 11 are placed on the one armoring sheets 21 while forming gaps with respect to the opposing inner side surfaces 50a, 50a (see FIG. 6C). Since the wire bundled portions 11 are placed with forming gaps with respect to the opposing inner side surfaces 50a, 50a, the side end portions 21a, 22a of the a pair of armoring sheets 21, 22 are ensured as portions to be bonded.

In a second armoring sheet setting step, then, the other armoring sheets 22 of the a pair of armoring sheets 21, 22 are set on the wire bundled portions 11, and in the positioning recess 50 so that the side end surfaces 22d, 22d of the other armoring sheets 22 are fitted to the insides of the opposing inner side surfaces 50a, 50a (see FIG. 6D). In this step, when the side end portions 22a, 22a of the other armoring sheets 22 are pressed against the side end portions 21a, 21a of the one armoring sheets 21 so that the side end portions 22a, 22a of the other armoring sheets 22 are closer to the side end portions 21a, 21a of the one armoring sheet 21, the side end portions 21a, 22a of the a pair of armoring sheets 21, 22 are bonded to each other more surely.

In a vacuum bonding step, finally, vacuuming is performed, the armoring sheets 21, 22 which are set in the plurality of places of the positioning recess 50 are bonded to each other while the wire bundled portions 11 are interposed therebetween, and the side end portions 21a, 22a are in close contact with each other (see FIG. 6E). In this step, the vacuuming performed by a vacuum pump 34 causes the vacuum sheet 31 to be in close contact with the whole surfaces of the other armoring sheets 22 while being evenly pressurized, and the side end portions 21a, 22a of the armoring sheets 21, 22 to be bonded in close contact with each other while the wire bundled portions 11 are flattened.

Even when the wire bundled portions 11 are moved so as to narrow the gaps with respect to the recess inner side surfaces, the side end portions 21a, 22a are bonded to each other before the wire bundled portions 11 are largely moved, because the a pair of armoring sheets 21, 22 are placed so as to be contacted with the wire bundled portions 11 and therefore the side end portions 21a, 22a which are in the armoring sheets 21, 22, and which are to be bonded to each other are close to each other.

In consideration of a phenomenon in which the other armoring sheets 22 at the upper-most set position are deformed along the wire bundled portions 11 into a chevron-like shape by vacuuming, the widths of the other armoring sheets 22 are adjusted to be larger than those of the one armoring sheets 21. According to the configuration, the side end portions 21a, 22a of the armoring sheets 21, 22 can be bonded to each other more surely.

In the method of attaching armoring sheets for a wire harness according to the embodiment of the invention, the side end surfaces 21d, 22d of the armoring sheets 21, 22 are positioned and guided to the bonding positions by the opposing inner side surfaces 50a, 50a, and the wire bundled portions 11 are placed so as to form gaps with respect to the opposing inner side surfaces. Therefore, the side end portions 21a, 22a of the armoring sheets 21, 22 can ensure parts which are necessary for bonding, with the result that bonding of the side end portions 21a, 22a of the armoring sheets 21, 22 can be surely performed.

In the method of attaching armoring sheets for a wire harness according to the embodiment of the invention, moreover, the armoring sheets 21, 22 are fitted to the positioning recess 50 while their widths are adjusted to the widths which are minimum necessary for bonding. Therefore, waste of the armoring sheets 21, 22 can be reduced.

In the method of attaching armoring sheets for a wire harness according to the embodiment of the invention, moreover, the fixing member 13 can be attached and fixed together with the armoring sheets 21, 22 to the wire harness 10 by the vacuum bonding step. Therefore, it is possible to enhance the efficiency of the work of attaching the fixing member, as compared to a fixing member which is lately attached to the armoring sheets 21, 22.

In the method of attaching armoring sheets for a wire harness according to the embodiment of the invention, in the case where the armoring sheets 21, 22 are to be bonded in a plurality of places correspondingly with the wire bundled portions 11 which are disposed in a plurality of places by the trunk portion 10a and branch portions 10b of the plurality of wires W, the branch portions branching off from the trunk portion, moreover, the a pair of armoring sheets 21, 22 in the plurality of places are set in the positioning recess 50, thereby enabling the armoring sheets to be concurrently vacuum bonded. Therefore, the work efficiency can be improved, and the work time can be shortened.

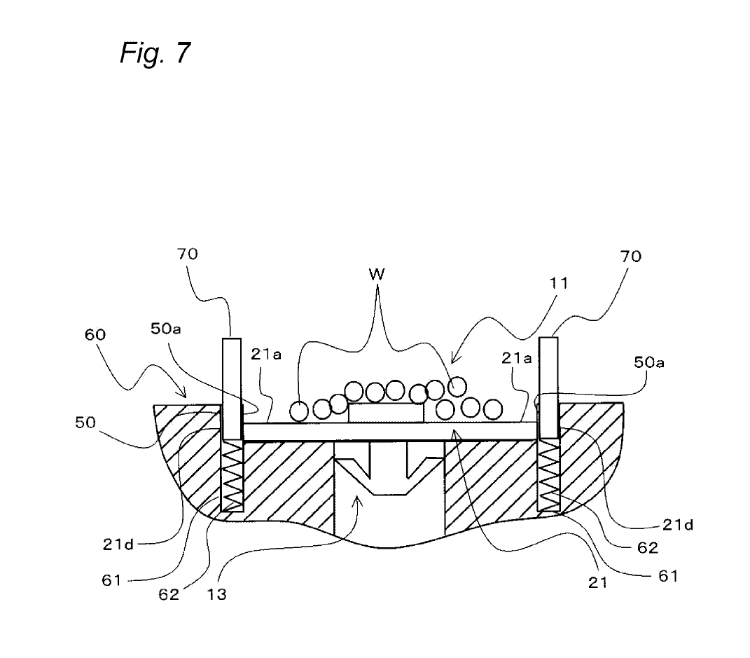

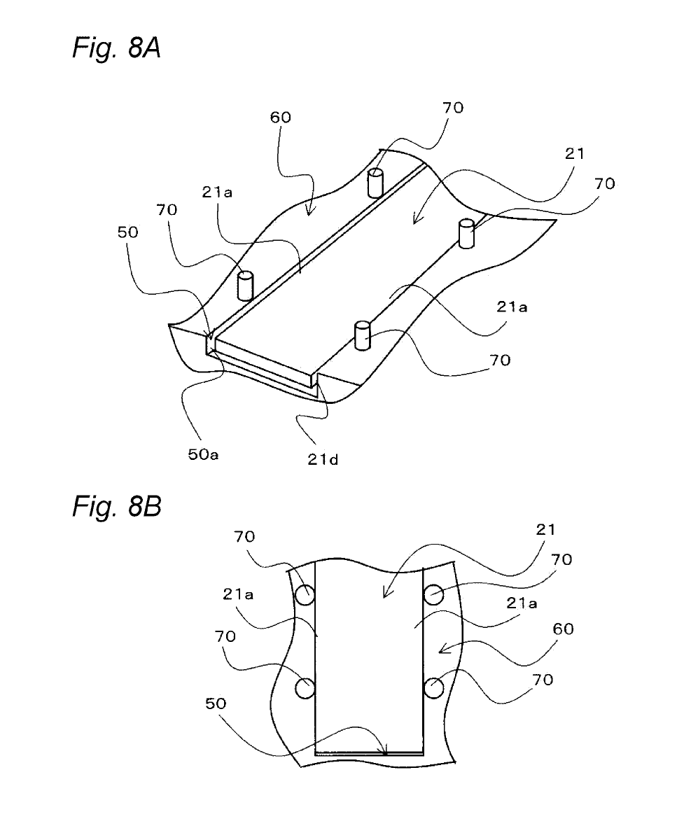

Next, a first modification of the method of attaching armoring sheets for a wire harness according to the embodiment of the invention will be described with reference to FIGS. 7 to 8B. FIG. 7 is a sectional view showing a setting jig 60 used in a method of attaching armoring sheets for a wire harness according to the modification of the invention, in a state where the one armoring sheet and the plurality of wires are set in a positioning recess 50 of the setting jig 60. FIG. 8A is a perspective view showing a state where the one armoring sheet 21 is set in the setting jig 60 shown in FIG. 7, and FIG. 8B is a top view of FIG. 8A.

The method of attaching armoring sheets for a wire harness according to the first modification is different from that of the embodiment in that guide pins 70 for guiding the wire bundled portions 11 are disposed in the setting jig 60.

The other configuration is identical with that of the embodiment, and the components which are identical with those of the embodiment are denoted by the same reference numerals.

The guide pins 70 guide the wire bundled portions 11 which are set in the positioning recess 50, so as to be maintained between the opposing inner side surfaces 50a, 50a. The guide pins 70 are held in a vertically movable manner by the configuration where the pins are set together with springs 62 in pin attachment holes 61 which are formed in the setting jig 60 so as to be projected from the upper end surface of the positioning recess 50 while the surface positions are aligned with the recess inner side surfaces 50a, 50a.

In the method of attaching armoring sheets for a wire harness according to the first modification, effects similar to those of the method of attaching armoring sheets for a wire harness according to the embodiment are achieved, and the wire bundled portions 11 which are set in the positioning recess 50 are guided by the guide pins 70 so as to be maintained between the opposing inner side surfaces 50a, 50a. Therefore, the wire bundled portions 11 can be set more surely in the positioning recess 50.

The guide pins 70 have a rod-like shape, and therefore portions interfering with the side end portions 21a, 22a of the armoring sheets 21, 22 can be suppressed to a smaller size. Consequently, the influence of the guide pins 70 on the bonding of the side end portions 21a, 22a of the armoring sheets 21, 22 can be suppressed to a smaller degree.

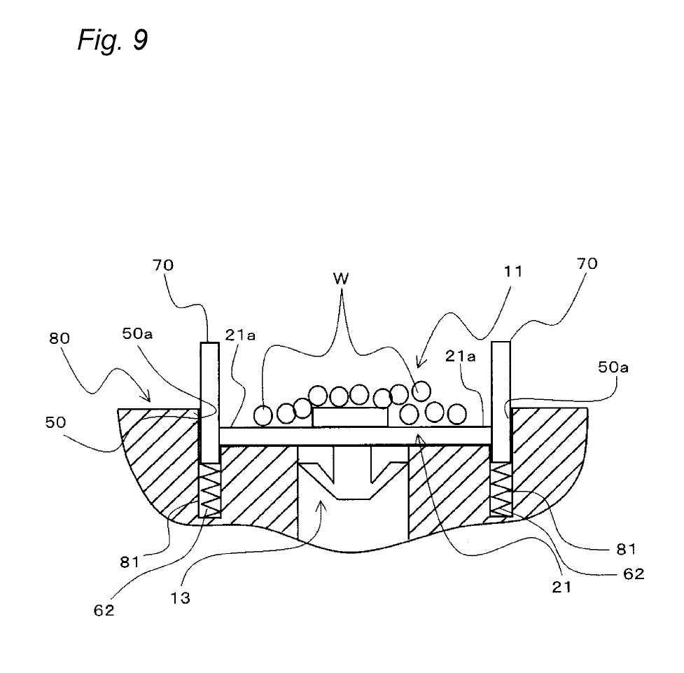

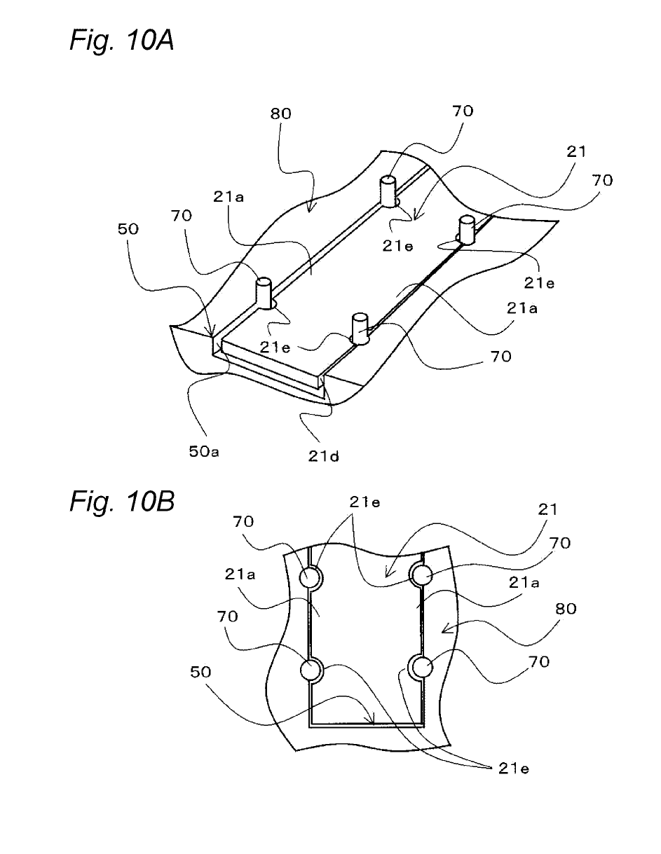

Next, a second modification of the method of attaching armoring sheets for a wire harness according to the embodiment of the invention will be described with reference to FIGS. 9 to 10B. FIG. 9 is a sectional view showing a setting jig 80 used in a method of attaching armoring sheets for a wire harness according to the second modification of the invention, in a state where the one armoring sheet 21 and the plurality of wires W are set in a positioning recess 50 of the setting jig 80. FIG. 10A is a perspective view showing a state where the one armoring sheet 21 is set in the setting jig 80 shown in FIG. 9, and FIG. 10B is a top view of FIG. 10A.

The method of attaching armoring sheets for a wire harness according to the second modification is different from that of the embodiment in that guide pins 70 for guiding the wire bundled portions 11 are disposed in the setting jig 80.

The other configuration is identical with that of the embodiment, and the components which are identical with those of the embodiment are denoted by the same reference numerals.

The guide pins 70 guide the wire bundled portions 11 which are set in the positioning recess 50, so as to be maintained in a state where gaps are formed with respect to the opposing inner side surfaces 50a, 50a. The guide pins 70 are held in a vertically movable manner by the configuration where the pins are set together with the springs 62 in pin attachment holes 81 which are formed in the setting jig 80 so that parts of the sections enter inside the recess inner side surfaces 50a, 50a.

In the armoring sheets 21, 22, in order to prevent interference with the guide pins 70 from occurring, semicircular cutaway portions 21e functioning as relief parts for the guide pins 70 are formed. Although the other armoring sheet 22 is not illustrated, cutaway portions are formed in a similar manner as those of the one armoring sheet 21.

In the method of attaching armoring sheets for a wire harness according to the second modification, effects similar to those of the method of attaching armoring sheets for a wire harness according to the embodiment are achieved, and the wire bundled portions 11 which are set in the positioning recess 50 are guided by the guide pins 70 so as to be maintained in the state where gaps are formed with respect to the opposing inner side surfaces 50a, 50a. Therefore, the side end portions 21a, 22a of the armoring sheets 21, 22 can more surely ensure parts which are necessary for bonding. Moreover, the cutaway portions 21e formed in the armoring sheets 21, 22 facilitate the positioning of the armoring sheets 21, 22 with respect to the positioning recess 50.

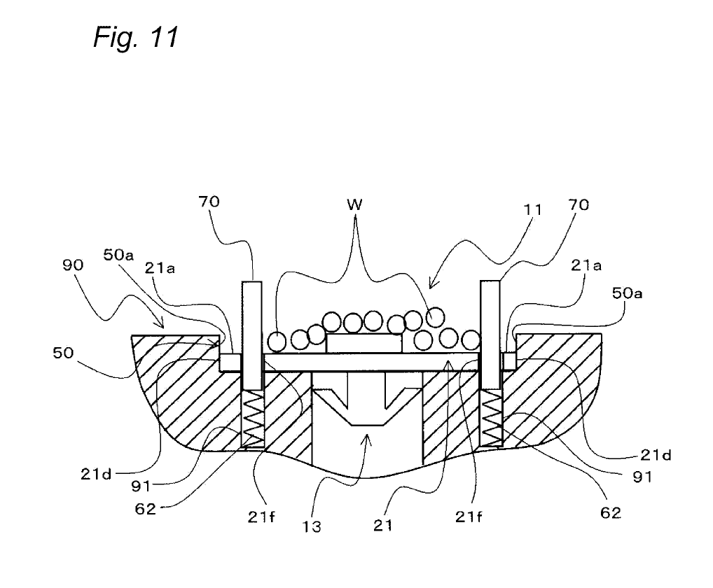

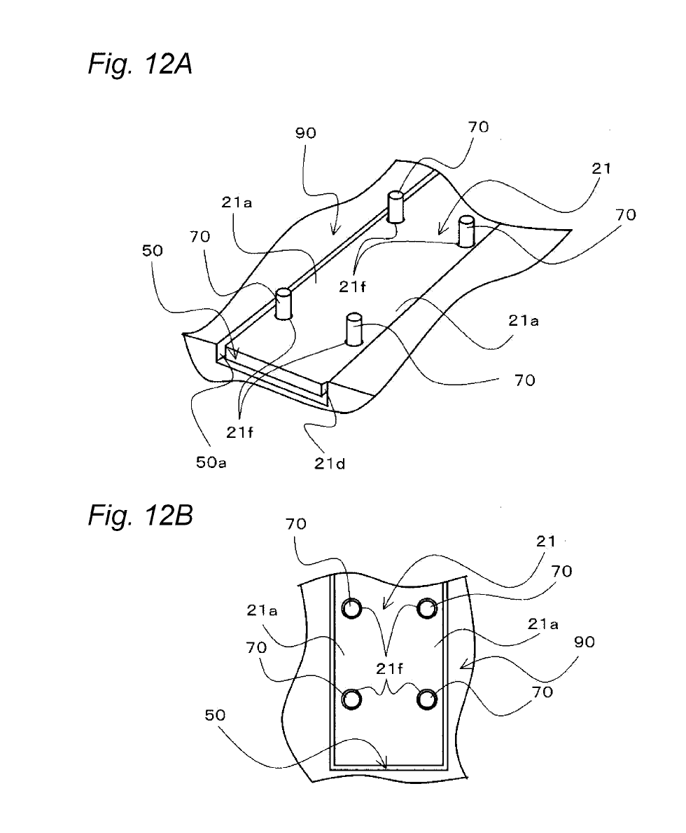

Next, a third modification of the method of attaching armoring sheets for a wire harness according to the embodiment of the invention will be described with reference to FIGS. 11 to 12B. FIG. 11 is a sectional view showing a setting jig 90 used in a method of attaching armoring sheets for a wire harness according to the third modification of the invention, in a state where the one armoring sheet 21 and a plurality of wires W are set in the positioning recess 50 of the setting jig 90. FIG. 12A is a perspective view showing a state where the one armoring sheet 21 is set in the setting jig 90 shown in FIG. 11, and FIG. 12B is a top view of FIG. 12A.

The method of attaching armoring sheets for a wire harness according to the third modification is different from that of the embodiment in that guide pins 70 for guiding the wire bundled portions 11 are disposed in the setting jig 90.

The other configuration is identical with that of the embodiment, and the components which are identical with those of the embodiment are denoted by the same reference numerals.

The guide pins 70 guide the wire bundled portions 11 which are set in the positioning recess 50, so as to be maintained in a state where gaps are formed with respect to the opposing inner side surfaces 50a, 50a. The guide pins 70 are held in a vertically movable manner by the configuration where the pins are set together with the springs 62 in pin attachment holes 91 which are formed in the recess bottom surface of the positioning recess 50.

In the armoring sheets 21, 22, in order to prevent interference with the guide pins 70 from occurring, pin insertion holes 21f through which the guide pins 70 are to be passed are formed as relief parts for the guide pins 70. Although the other armoring sheet 22 is not illustrated, pin insertion holes are formed in a similar manner as those of the one armoring sheet 21.

According to the method of attaching armoring sheets for a wire harness according to the third modification, effects similar to those of the method of attaching armoring sheets for a wire harness according to the embodiment are achieved, and the wire bundled portions 11 which are set in the positioning recess 50 are guided by the guide pins 70 so as to be maintained in the state where gaps are formed with respect to the opposing inner side surfaces 50a, 50a. Therefore, the side end portions 21a, 22a of the armoring sheets 21, 22 can more surely ensure parts which are necessary for bonding. Moreover, the pin insertion holes 21f formed in the armoring sheets 21, 22 facilitate the positioning of the armoring sheets 21, 22 with respect to the positioning recess 50.

As the method of attaching armoring sheets for a wire harness according to the embodiment of the invention, the method including the fixing member setting step has been exemplified. The invention is not limited to this, and is directed also to a method which does not include a fixing member setting step.

As the method of attaching armoring sheets for a wire harness according to the embodiment of the invention, the method in which the wire bundled portions 11 are disposed in a plurality of places of the wire harness 10, and the armoring sheets 21, 22 are attached to the plurality of places has been exemplified. The invention is not limited to this. The invention is directed also to a configuration where the armoring sheets 21, 22 are attached to a single wire bundled portion 11 disposed in the wire harness 10.

In the method of attaching armoring sheets for a wire harness according to the embodiments above, the side end surfaces of the armoring sheets are positioned and guided to the bonding position by the opposing inner side surfaces, and the wire bundled portion is placed so as to form gaps with respect to the opposing inner side surfaces. Therefore, the side end portions of the armoring sheets can ensure parts which are necessary for bonding, and the side end portions of the armoring sheets can be surely bonded to each other.

Since the armoring sheets are fitted to the positioning recess while being adjusted to the width which is minimum necessary for bonding the armoring sheets to each other, waste of the armoring sheets can be reduced.

Since the wire bundled portion which is set in the positioning recess is guided by the guide pins so as to be maintained in the state where the gaps are formed with respect to the opposing inner side surfaces, the side end portions of the armoring sheets can more surely ensure parts which are necessary for bonding.

Since the fixing member can be attached and fixed together with the armoring sheets to the wire harness by the vacuum bonding step, it is possible to enhance the efficiency of the work of attaching the fixing member, as compared to a fixing member which is lately attached to the armoring sheets.

In the case where the armoring sheets are to be bonded in a plurality of places correspondingly with the wire bundled portions which are disposed in a plurality of places by the trunk portion and branch portions of the plurality of wires W, the branch portions branching off from the trunk portion, the armoring sheets in the plurality of places are set in the positioning recess, thereby enabling the armoring sheets to be collectively vacuum bonded. Therefore, the work efficiency can be improved, and the work time can be shortened.

Although the invention contemplated by the inventor has been specifically described with the embodiment of the invention, the invention is not restricted to the above-described embodiment, and various changes can be made without departing from the spirit of the invention.

What is claimed is:

1. A method of attaching armoring sheets for a wire harness, comprising:
a first armoring sheet setting step of setting one of a pair of the armoring sheets in a positioning recess formed in a setting jig to fit side end surfaces of the one of the armoring sheets to insides of opposing inner side surfaces of the positioning recess, so as to position the one of the armoring sheets;
a wire setting step of setting wires in the positioning recess so as to place a wire bundled portion on the one of the armoring sheets while forming gaps with respect to the opposing inner side surfaces, wherein the wire bundled portion is a portion in which the wires of the wire harness are bundled;
a second armoring sheet setting step of setting the other of the armoring sheets in the positioning recess to fit side end surfaces of the other of the armoring sheets to the insides of the opposing inner side surfaces, so as to cover the wire bundled portion; and
a vacuum bonding step of performing vacuuming to bond the armoring sheets which are set in the positioning recess, to each other, so that side end portions of the armoring sheets are in close contact with each other in a state that the wire bundled portion is interposed between the armoring sheets.

2. The method according to claim 1,
wherein a distance between the opposing inner side surfaces is adjusted so that a region which is minimum necessary for bonding the side end portions of the armoring sheets which are fitted to the positioning recess is formed.

3. The method according to claim 1,
wherein, in the wire setting step, the wire bundled portion is guided by guide pins so as to maintain the gaps.

4. The method according to claim 1, further comprising:
a fixing member setting step of setting a fixing member to the one of the armoring sheets so that a part of the fixing member is disposed on a bonding surface of the one of the armoring sheets, wherein the fixing member is configured to fix the wire harness to a mating member,
wherein, in the first armoring sheet setting step, the one of the armoring sheets is set in the positioning recess together with the fixing member,
wherein, in the second armoring sheet setting step, the other of the armoring sheets is set in the positioning recess so as to cover the wire bundled portion and the part of the fixing member, and
wherein, in the vacuum bonding step, the armoring sheets which are set in the positioning recess are bonded to each other so that the side end portions are in close contact with each other in a state that the wire bundled portion and the part of the fixing member are interposed between the armoring sheets.

5. The method according to claim 1,
wherein, in the vacuum bonding step, a plurality of parts of the armoring sheets which are set in a plurality of positions in the positioning recess are bonded to each other by being vacuumed concurrently.
